(19) United States
(12) Patent Application Publication
(10) Pub. No.: US 2009/0107945 A1
(43) Pub. Date: Apr. 30, 2009

(54) Folding Boom

(76) Inventor: Franz Ehrenleitner, Altensteig-Walddorf (DE)

Correspondence Address: FRIEDRICH KUEFFNER, 317 MADISON AVENUE, SUITE 910, NEW YORK, NY, 10017, US

(21) Appl. No.: 11/989,499

(22) PCT Filed: Jul. 11, 2006
(86) PCT No.: PCT/AT2006/000297

§ 371 Date: Nov. 3, 2008

(30) Foreign Application Priority Data
Jul. 29, 2005 (AT) A 1284/2005
Jul. 5, 2006 (AT) A 1143/2006

(51) Int. Cl. B66C 23/34

(52) U.S. Cl. 212/176; 52/123.1

(57) ABSTRACT

The invention concerns a collapsible boom, such as a crane jib, concrete pump, camera support, searchlight mast and similar narrow far-projecting structures with several elements (10, 20, 30 . . . ), tiltable around parallel axes, which can be tilted around the axis by actuators (15, 13, 25, 23, . . . ) and fixed in at least one position.

The invention is characterized by the fact that the individual elements (10, 20, 30 . . . ) of the boom are hinged to each other via intermediate pieces (50, 60, 70) and the actuators (15, 13, 25, 23, . . . ) engage on one end on an intermediate piece and on the other end on its adjacent element.

The invention concerns hinged crane jibs, concrete pumps, camera supports, light masts and similar narrow, but far-projecting structures that are generally mounted on trucks, their trailers or railway cars.

Such structures, referred to subsequently merely as “booms”, are supposed to have high range, on the one hand, high support capability in most cases (crane jibs), but, on the other hand, are supposed to be light, so that the supporting vehicles can also be used at construction sites and on ground with limited loadability, and they must be able to collapse small enough, so that they can be moved in ordinary traffic without special transport.

Known devices of this type have collapsible sections running zig-zag around parallel axes, in which hydraulic cylinder-piston units are arranged essentially parallel to the individual components in the extended state, which keep the individual elements, which are always subject to bending stress, in the desired position relative to each other.

These devices have certain shortcomings that are quite obviously inherent to the employed serial kinematics: in order to be collapsed, the individual components must be designed offset, which means that even in the extended state, a kinked arrangement is present, which also results in a kinked force trend, so that the individual elements, depending on the corresponding load lever, are stressed much more strongly than would be the case in an extended arrangement.

To this it must be added that for the contemplated use, a profile with the largest possible cross-section is sought, which can transfer larger torques through the higher geometrical moment of inertia, but in the collapsed state, the smallest possible cross-sections are required, in order to be able to maintain the mentioned geometric limits.

The invention seeks to devise a boom, which does not have the mentioned drawbacks and has high rigidity, especially at low weight, and can be collapsed into the narrowest space.

These objectives are achieved according to the invention in that the individual elements of the boom are articulated to each other via intermediate pieces, and that actuators are provided, which engage on one end on the intermediate pieces and on the other end on the components.

Actuators in this description and the claims are understood to mean devices, such as hydraulic or pneumatic cylinder-piston units, and electrical adjustment drives, such as spindle-nut drives or, if pure tensile forces are to be transferred, also tension elements, such as cables, belts or chains can also be present.

Through the expedient according to the invention, the individual components are only connected to pivot via the intermediate pieces, but the actuators do not engage between the components, but between the intermediate pieces, on one end, and the components, on the other end. Through this apparently simple expedient, an entire series of unexpected advantages is gained:

A first major advantage is that this arrangement makes it possible to break down the entire boom element for element and intermediate piece for intermediate piece into frameworks, viewing the entirety as a uniform framework, in which some of the rods, namely the actuators, are designed variable in length.

A second major advantage is that through the expedient according to the invention, each individual element, and therefore also the boom in its entirety, can be made linear without offset, since the intermediate pieces, during collapse, ensure that the individual adjacent elements have the spacing from each other necessary for collapse, while these intermediate pieces in the extended state of the boom again ensure that it is formed fully extended.

The invention is further explained below with reference to drawings.

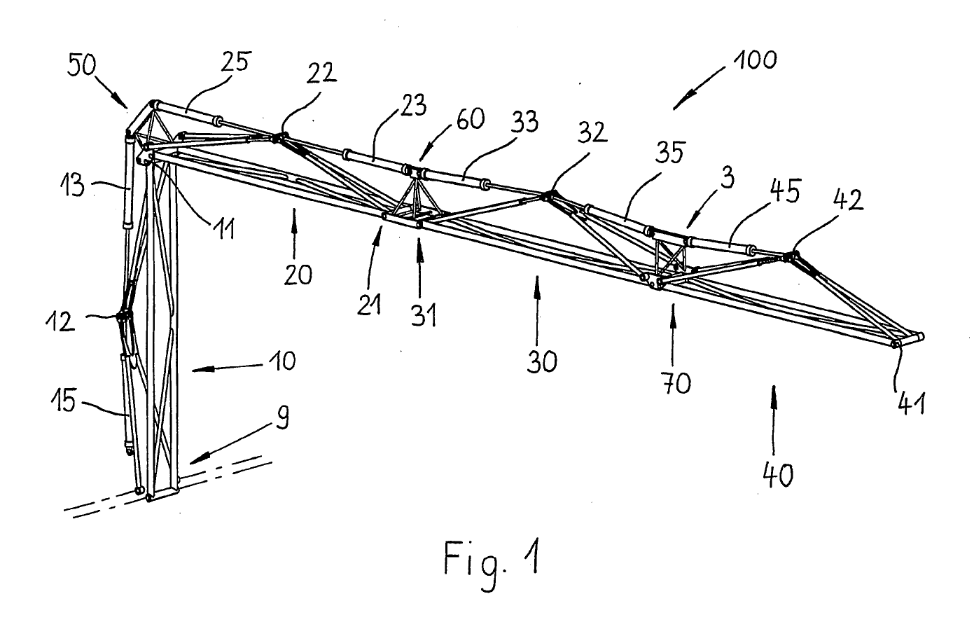

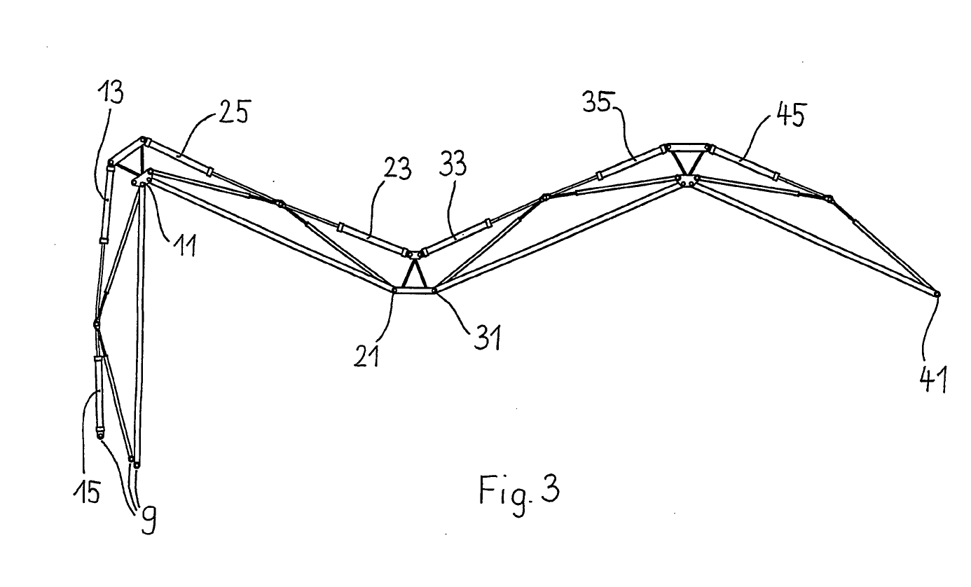

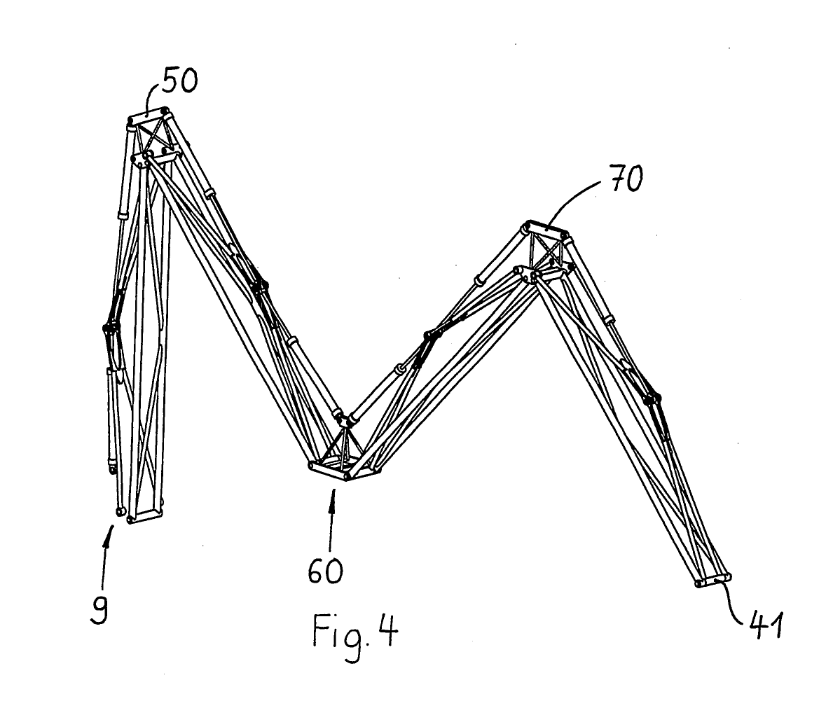

FIG. 1 to 6 show a boom according to the invention in different stages of collapse partially in a side view and partially in a perspective view,

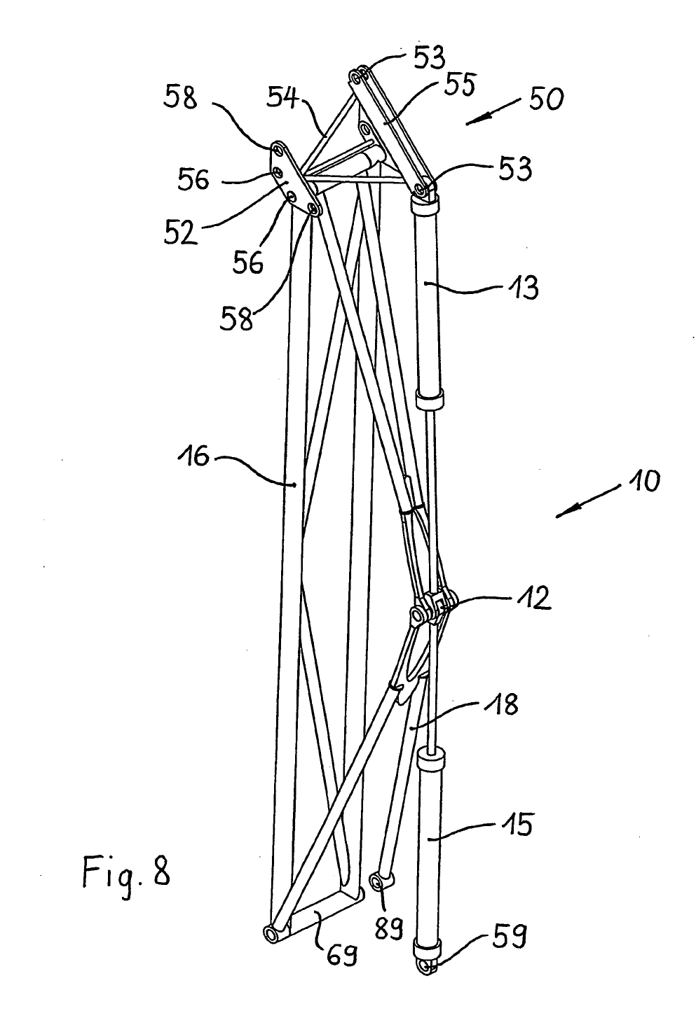

FIG. 7 and 8 show the basic structure of one element, and

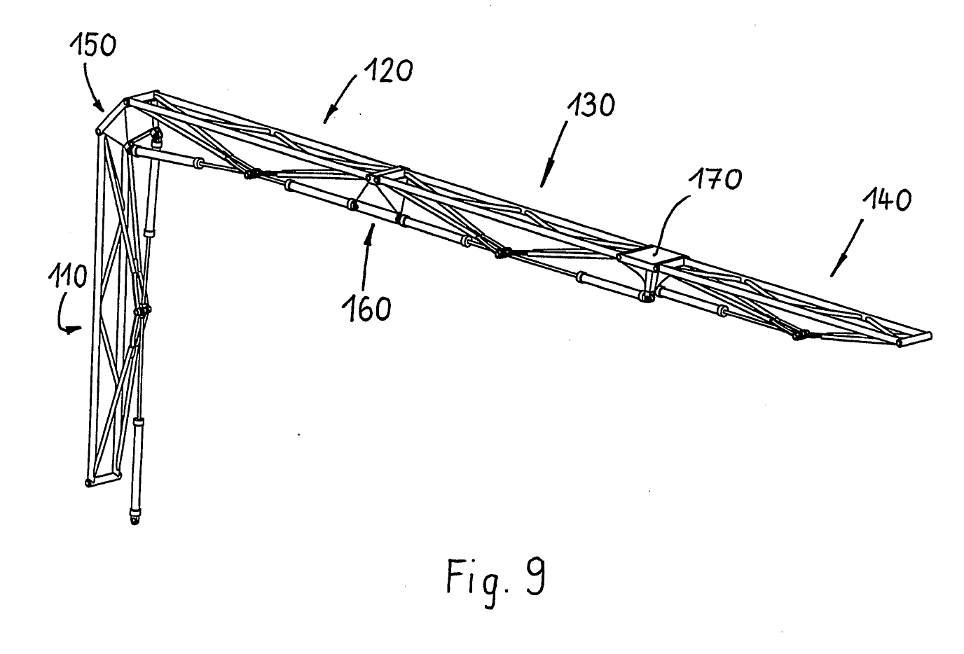

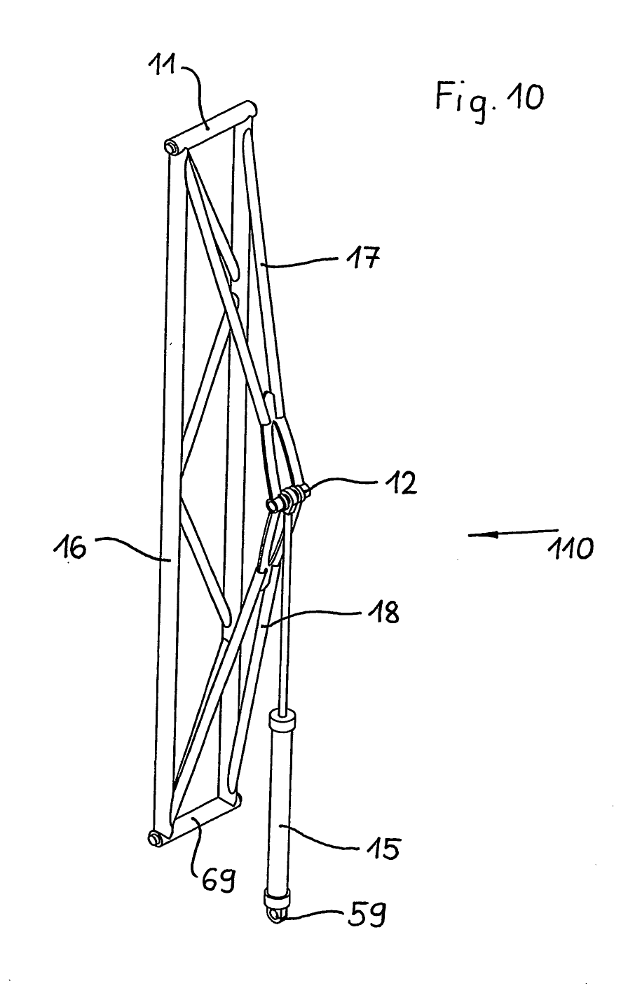

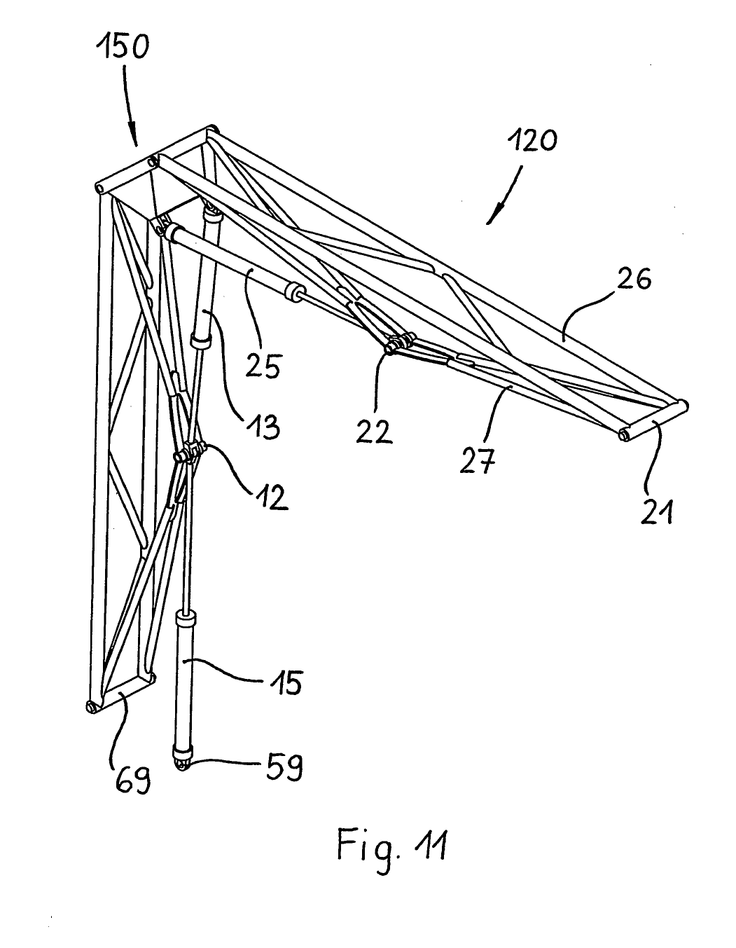

FIG. 9 to 12 show a variant.

Since the invention concerns devices that include numerous identical or at least almost identical elements arranged in series, these elements were designated 10, 20, etc. and their components, assigned by using the matching number in the tens place of the individual elements. When such components are described, in general, the general index “i” is used, instead of arduous numbering.

FIG. 1 to 6 show a boom according to the invention, which consists of four identical elements 10, 20, 30 and 40 (subsequently i0) and three intermediate pieces 50, 60 and 70, two different types of intermediate pieces being provided, namely two outer intermediate pieces 50, 70 and an inner intermediate piece 60, which lies between the outer intermediate pieces.

An actuator 13, 25, 23, 33, 35, 45, which in the depicted practical example, is a hydraulic cylinder-piston device, goes from each of the intermediate pieces to each of the adjacent elements and, in most applications, such devices are designed double-acting. In applications, in which it is reliably established that the actuators are only subject to tension, it is possible to design them as tension devices, such as cables, belts, chains or the like.

FIG. 1 shows the working position of a concrete pump or crane, in which the actual working device and its supply lines are not shown, for reasons of simplicity. In the practical examples according to FIG. 1 to 6, the first element 10 of the device 100 is used as a sort of tower for the boom and is therefore arranged essentially vertically. This element 10 is imagined to be arranged with its foot point 59, 69, 89, designated in their entirety with 9, on a platform or foundation or base block (not shown), and this platform can be mounted to rotate, for example, around the vertical axis on a vehicle, a trailer, a railroad car or the like.

The individual elements i0, according to the invention, have the following structure, which is best apparent from FIGS. 7 and 8: these figures show the element 10, with the following intermediate piece 50 in FIG. 8. The element 10 essentially consists of a longitudinal rod 16, on one end of which, head point 11, a shear rod 17 is hinged, whose other end, called comb point 12, is connected to one of the ends of actuator 15. A secondary rod 18 leads from this comb point 12 between shear rod 17 and actuator 15 to a foot point 89 (linkage point or linkage axis), which lies next to the foot point 69 of longitudinal rod 6. These foot points 9 of actuator 15, longitudinal rod 16 and secondary rod 18 are now linked to a rigid foundation of the device (not shown).

When the length of actuator 15 is changed with fixed foot points 9, its other end in comb point 11 must be moved along the circle, which is capable of striking the head point of the secondary rod 18 around its foot point 89. Through this movement of the comb point 12, viewed as the foot point of shear rod 17, the shear rod 17 acts as a foot point-operated actuator on the end point 11 of longitudinal rod 16, which again can be rotated exclusively around its foot point 69, and thus changes the geometry of element 10 and the position of the end point 11 equally. An intermediate actuator 13 engages on comb point 12 with its foot point, its head point is linked to intermediate piece 50 and thus causes its rotation around the axis defined by end point 11 (perpendicular to the plane of the drawing), and therefore creates the transition to the next element of the kinematic chain.

This is especially apparent from FIG. 8, in which the intermediate piece 50 is shown on the end of element 10: it consists essentially of an inner plate 52, an outer rod 55 and connection rods 54. The designation “inner” or “outer” was chosen with respect to the position in the collapsed state of device 100, and “actuator rod 55” and “frame plate 52” would also be suitable. Bearings 56 for longitudinal rods 16 and 26 are provided on the inner plate 52 and bearings 57 for the shear rods 17, 27 of the adjacent elements 10, 20. The outer rod 55 carries bearings 53 for the intermediate actuator 13 and actuator 25 of the adjacent elements 10, 20. This linkage of the next element 20 is readily apparent from FIG. 1. As is directly apparent, the bearing 57 is unused on the side of element 10, since this element is linked on intermediate piece 50 to its end point 11.

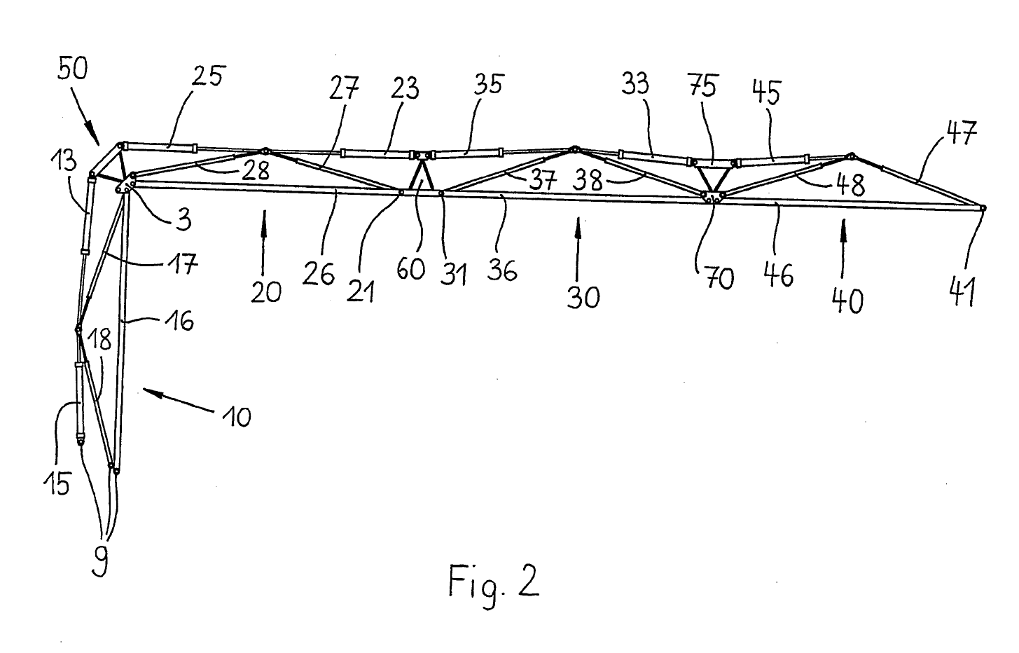

The second outer intermediate piece 70 is designed the same, since the two adjacent elements 30 and 40 each engage with their foot point, and all bearings of the intermediate piece are occupied and the actuators 35, 45 engage on both sides on the outer rod 75 (FIG. 2).

If, as is apparent in FIG. 1, the end point 11 of element 10 engages on the outer intermediate piece 50 and an additional so-called intermediate actuator 13 is provided between comb point 12 and intermediate piece 50, the chain of individual parallel kinematic devices shown in FIG. 1 is obtained, since the individual elements i0, as explained with reference to FIGS. 7 and 8, represent parallel kinematic devices of a special type.

The design and arrangement of the element 10, used as a tower, will be taken up briefly with reference to FIG. 1: this element corresponds to the element shown in FIG. 7 in another view, in which the foot points 9 are actually viewed as “true” foot points of the entire device 100 on a platform or the like. The subsequent element 20 next to the tower is linked on the outer intermediate piece 50 on the upper end of the tower to its foot points 9, so that the inner intermediate piece 60, just as the outer intermediate piece 70, actually establishes a local plane of symmetry.

Collapse of boom 1 is apparent from the sequence in FIG. 1 to 6, from which it follows that by increasing lengthening of actuators i5 and increasing simultaneous shortening of actuators i3, the extended position of boom 1 is left and its collapse form is increasingly reached. It should also be observed that the height of the individual elements i0, which is the extent normal to the axis of the longitudinal rods i6, and from this axis and the pivot axis of foot point 69, the longitudinal rods i6 increasingly diminishes during collapse, which means that, on the one hand, the height extent of elements i0 and therefore the geometric moment of inertia in the working position is high, whereas in the collapsed position, it only occupies limited space. This occurs by the increasing length change of the individual foot points 9 of actuators i5 of secondary rods i8 and longitudinal rods i6.

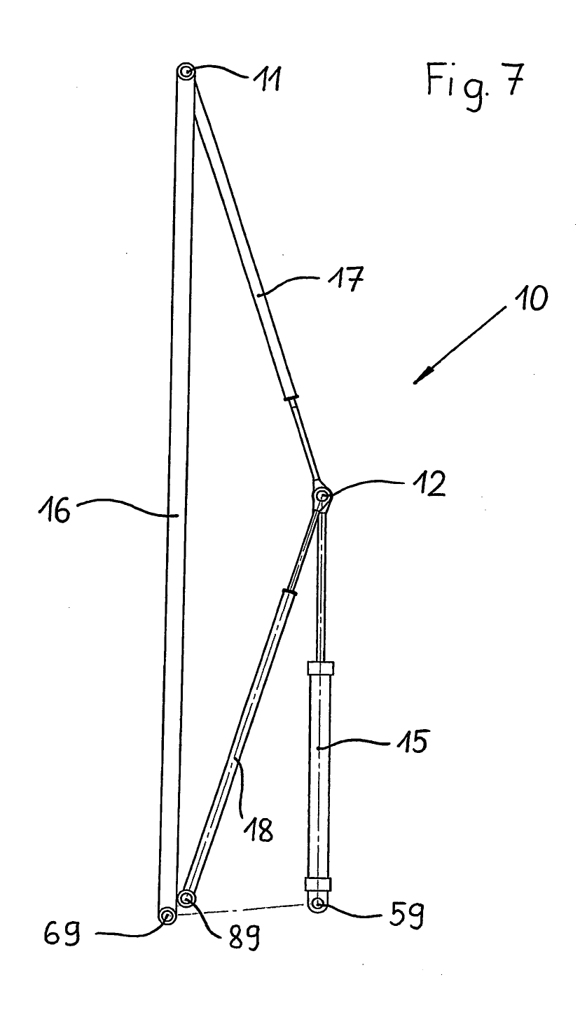

FIG. 6 finally shows the extremely compact arrangement of the collapsed boom 1, which can be tilted around a horizontal axis and thus positioned on its vehicle. It also follows from the sequence of figures why the intermediate piece 4 is referred to as inner intermediate piece, since it is situated in the inside in the collapsed state between the longitudinal rods 6 and the adjacent elements 2, whereas the outer intermediate pieces 3 almost enclose the longitudinal rods 6 of the adjacent elements 2 on the outside.

FIGS. 7 and 8 show, as already stated above, one of the elements, in which element 10 was chosen, since it is well suited for this from the viewing angle. The other elements are designed completely the same, which, however, need not be the case, apart from the kinematic properties. If one assumes in FIG. 1, for example, that the device according to the invention is used as a crane, it is quite clear that the elements 20, 30 and 40 are loaded differently during the lifting of a load in the area of end point 41, and therefore are advantageously designed with different strengths in order to save weight. Identically designed elements will only be used if one intends to utilize the advantage of a pure modular system, as shown in the present invention for the sake of simplicity.

Back to FIGS. 7 and 8, it is apparent that an element 10, designed according to the invention, has foot points 59, 69 and 89 of actuator 15, longitudinal rod 16 and secondary rod 18, which, already because of the symmetric design of the device, are perpendicular to the plane of the drawing and are not designed point-like, because of the necessary transfer of transverse forces and torques, but, as is apparent from FIGS. 1 and 8, rotation around parallel axes is permitted. In FIG. 8, the axes of foot points 68, 89 appear to be flush, but this is only a result of the viewing angle.

The element 10 consists of a longitudinal rod 16, which, in the actual variant, is designed as a frame and in the use according to FIG. 1, experiences pressure in the direction of the main axis of longitudinal rod 16. The transverse forces that unavoidably occur during use as a crane, for example, are taken up and transferred by the frame-like structure. Since the invention concerns essentially the new kinematic concept, the design itself is indicated in the drawings, but is not specially described below.

The element 10 also has secondary rods 18, whose head point is designed together with the head point of actuator 15 and forms a so-called comb point 12 there. Shear rods 17 also engage in this comb point and an intermediate actuator 13.

The head points of shear rod 17, which kinematically act as a single rod, as is apparent from FIG. 7, and the head point of longitudinal rod 16, form an end point 11, configured as a bearing, around which an intermediate piece 50 can be pivoted. The intermediate actuator 13 then engages on a linkage 53 of intermediate piece 50.

The intermediate piece 50 is designed essentially symmetric around two planes, the plane of the drawing and a plane normal to it in the extended state of the device, and on each side, assigned to an element 10, 20, has linkage points 53, the foot point of an intermediate actuator i3 and an actuator i5; linkage points 56 for the head points or foot points 11, 69 of the longitudinal rods i6 and the linkage points 58 for the foot points 89 of the secondary rods i8.

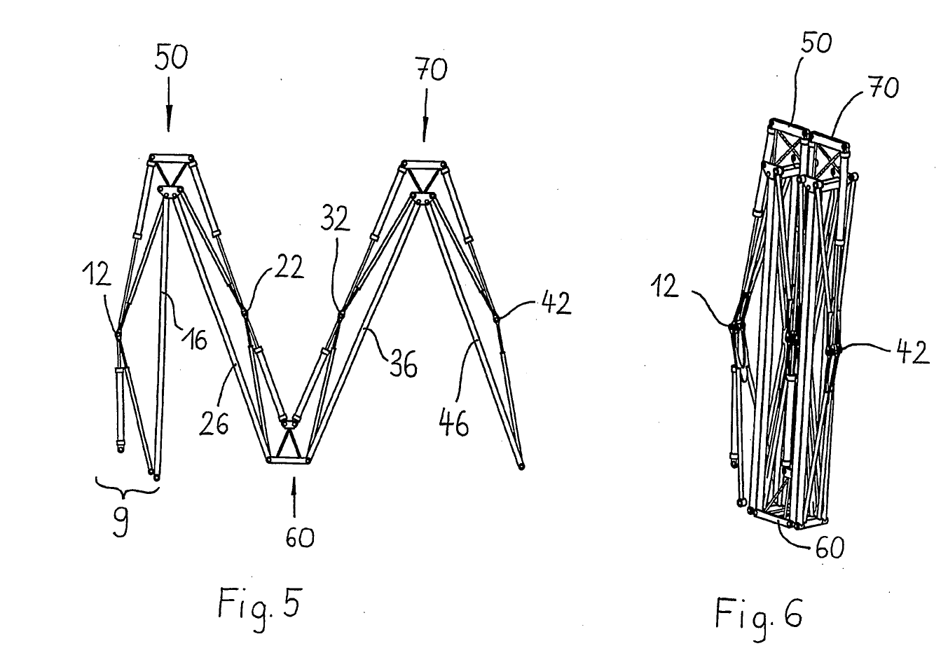

The inner intermediate piece 60 (FIG. 1) is designed differently than the outer intermediate pieces 50 and 70 and consists essentially of a pyramid-shaped framework, on whose vertex two intermediate actuators 23, 33, and on whose base two end points 21, 31 engage. The linkage axes of these intermediate actuators preferably have only enough spacing from each other, so that in the retracted state of device 100, they lie right next to each other (FIGS. 5 and 6), since the largest gain of space is achieved in this way. The base of the pyramid likewise has an extent, so that the longitudinal rods 26, 36 (or their frames) also come to lie as close as possible to each other, in which sufficient space for the shear rods 27, 37 must be considered.

A variant of the invention is shown in FIG. 9 to 12. The individual elements 110 to 140 are arranged similarly to the intermediate elements 150, 160 and 170, as in practical example 1, but are designed more simply, to the extent that they are formed as a type of rigid, pyramid-shaped framework and the axis 69, 89 actually permanently coincide, so that they can be designed as a rigid frame for reasons of simpler design. Apart from the different designations for the individual elements, the same designation was retained for their elements, if present.

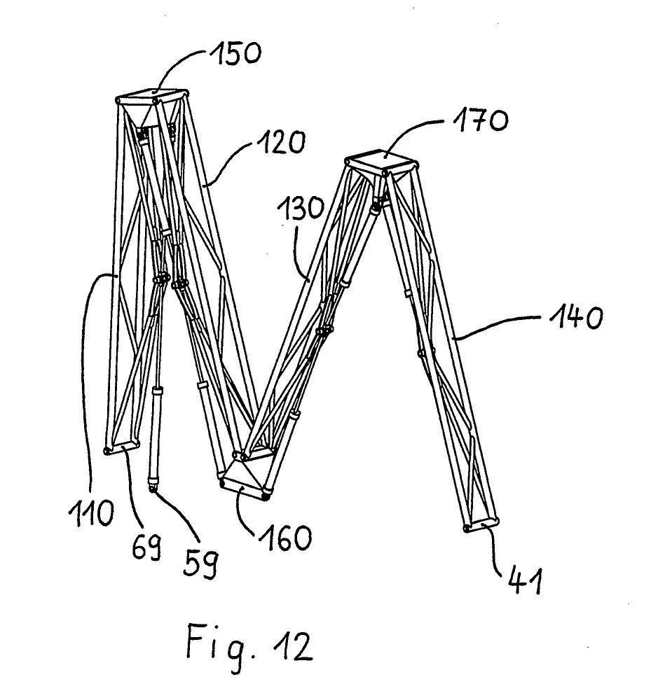

As follows from FIGS. 9 and 11, a consequence of the simplified kinematic is that the actuators can no longer engage in the center on intermediate elements 150, 160 and 170, but the linkage points must be offset relative to each other in directions across the plane of symmetry of the device and therefore in the direction of the pivot axes. In particular, this is significant in intermediate element 150, since intersection of the two actuators in space occurs here. Their engagement points, as shown by FIG. 11, in particular, do not lie on a line running parallel to the pivot axes, but on an oblique line.

In order to sketch this possibility, the chain of actuators in this practical example (for the usual case) was also designed as a pressure rod. As shown, in particular, in FIG. 12, the excellent collapsibility is present. It is immediately apparent, based on the design principle with rigid pyramid-shaped elements, that during collapse, no change in design height of the individual elements occurs, so that the additional gain of greater height, outlined in the first practical example in the working state, and smaller height in the transport state, cannot be achieved here. It is naturally clear that even in this practical example, the use of identical components is not optimized even with unequal loading, and the depiction involves the function of the kinematics and not the use of force-optimized design principles.

The invention is not restricted to the depicted examples, but can be modified in different ways. Thus, another breakdown of the individual elements into frameworks is possible, the number of elements per device can be chosen differently, it is not necessary to form one of the elements as a tower, intermediate elements that permit “kinking” of the boom around axes with another orientation can be used and, in particular, the last element can be designed to pivot rightward and leftward around a vertical axis. If transfer of forces does not matter as much, but use under severe geometric boundary conditions, the elements can be designed shorter and the intermediate pieces made in two parts and optionally rotatable around the longitudinal axis (in the extended state), which facilitates use in the interior of buildings (concrete pumps) or auto bodies (painting plant).

However, it is essential that the device, at least in one section, consists of an alternation of elongated elements and intermediate pieces, and that not only actuators, generally hydraulic cylinder-piston units, but also spindle-nut drives or linear electronic adjustment drives, in special cases also flexible tension devices, like cables, chains, etc., engage on one end on the elements and on the other end on the adjacent intermediate pieces.

1. Collapsible boom, such as a crane jib, concrete pump, camera support, searchlight mast and similar narrow far-projecting structures with several elements, tiltable around parallel axes, which are tilted by actuators around the axes and can be fixed in at least one position, wherein the individual elements of the boom are hinged to each other via intermediate pieces, and that the actuators engage on one end on an intermediate piece and on the other end engage on an element adjacent to it.

2. Boom according to claim 1, wherein the elements have essentially the same length.

3. Boom according to claim 1, wherein the intermediate pieces are designed essentially shorter in the direction of the boom axis than the elements of the boom.

4. Boom according to claim 1, wherein the actuators essentially engage in the center of the elements.

5. Boom according to claim 1, wherein the actuators of one element engage on a common engagement site on the element.

6. Boom according to claim 1, wherein at least two adjacent elements consist of a longitudinal rod (16), a shear rod (17) hinged on its end point (11) and a secondary rod (18) hinged on the other end of the shear rod, the comb point (12), and extending in the vicinity of the foot point (69) of the longitudinal rod (16), with the actuators (13, 15) being hinged at the comb point (12).

7. Boom according to claim 1, wherein at least two adjacent elements each consist of a longitudinal rod (16), a shear rod (17) engaging on its end point (11) and a secondary rod (18) linked on the other end of the shear rod, the comb point (12), discharging at the foot point (69) of longitudinal rod (16), with the actuators (13, 15) being hinged at the comb point (12).

8. Boom according to claim 1, wherein at least one intermediate piece (50, 70) has connection points (53) on each of its sides that are assigned to an adjacent element (10, 20), the foot point of an intermediate actuator (13) and an actuator (25); and connection points (56) for the head points and foot points (11, 69) of the longitudinal rods (16, 26) and the connection points (58) for the foot points (89) of the secondary rods (18) of the adjacent elements, in which the distances between the connection points (53) for actuators (13, 25) are at least twice as large, preferably three times as large, as the spacings between the connection points (56) for the longitudinal rods (16, 26).

9. Boom according to claim 1, wherein it has at least one intermediate piece (60) that has an essentially pyramid shape, and that its connection points for actuators (23, 33) of adjacent elements (20, 30) have a spacing that is smaller than half, preferably smaller than one-third, of the spacing associated with the connection points for the end points (21, 31) of longitudinal rods of the adjacent elements.
